(19) United States
(12) Patent Application Publication
(10) Pub. No.: US 2014/0101144 A1
(43) Pub. Date: Apr. 10, 2014

(54) Methods and Systems for Displaying Microblog Topics

(71) Applicant: Tencent Technology (Shenzhen) Company Limited, Shenzhen (CN)

(72) Inventors: Nian Liu, Shenzhen (CN); Qunli Ma, Shenzhen (CN); Huaheng Fan, Shenzhen (CN); Xun Zhang, Shenzhen (CN); Ziming Wang, Shenzhen (CN); Wei Wu, Shenzhen (CN); Chuan Peng, Shenzhen (CN); Yang Li, Shenzhen (CN)

(73) Assignee: Tencent Technology (Shenzhen) Company Limited, Shenzhen (CN)

(21) Appl. No.: 14/098,641

(22) Filed: Dec. 6, 2013

Related U.S. Application Data
(63) Continuation of application No. PCT/CN2013/078635, filed on Jul. 2, 2013.

(30) Foreign Application Priority Data
Jul. 3, 2012 (CN) 201210227368.2

(51) Int. Cl. G06F 17/30

(52) U.S. Cl. CPC G06F 17/30554
USPC 707/723

(57) ABSTRACT

Methods and mobile terminals are provided for displaying microblog topics. An example method includes, sending by a mobile terminal a post that includes at least a first geographic location of the mobile terminal to a server so that the server can search for microblog topics associated with the first geographic location of the mobile terminal based on at least information associated with the post, receiving the microblog topics sent by the server, and sorting the received microblog topics. The method further includes, displaying one or more first microblog topics of the sorted microblog topics on a center area of an interface of the mobile terminal, and displaying the rest of the sorted microblog topics around the center area toward one or more sides of the interface.

### 1. CROSS-REFERENCES TO RELATED APPLICATIONS

This application claims priority to Chinese Patent Application No. 201210227368.2, filed Jul. 3, 2012, incorporated by reference herein for all purposes.

### 2. BACKGROUND OF THE INVENTION

The present invention is directed to communication technology. More particularly, the invention provides systems and methods for displaying information. Merely by way of example, the invention has been applied to microblogs. But it would be recognized that the invention has a much broader range of applicability.

Microblog is a type of user relation-based platform for information sharing, spreading and capture. To enrich leisure time, a user can post a microblog topic, or take part in a discussion related to a microblog topic by posting microblogs. Moreover, a server can push a microblog topic to a mobile terminal (e.g., a cell phone, a tablet computer, or a laptop) so that the mobile terminal can obtain the microblog topic.

In a conventional technology, when a server receives from a mobile terminal a post that contains a geographic location of the mobile terminal, the server searches a list of microblog topics, and pushes to the mobile terminal those microblog topics associated with the geographic location of the mobile terminal. The mobile terminal will display the received microblog topics. If the mobile terminal receives multiple microblog topics, these microblog topics will be displayed using a same list format or a same tag format.

But the conventional display technology has some disadvantages. Hence it is highly desirable to improve the techniques for displaying microblog topics.

### 3. BRIEF SUMMARY OF THE INVENTION

The present invention is directed to communication technology. More particularly, the invention provides systems and methods for displaying information. Merely by way of example, the invention has been applied to microblogs. But it would be recognized that the invention has a much broader range of applicability.

According to one embodiment, a method for displaying microblog topics includes: sending by a mobile terminal a post that includes at least a first geographic location of the mobile terminal to a server so that the server can search for microblog topics associated with the first geographic location of the mobile terminal based on at least information associated with the post, receiving the microblog topics sent by the server, and sorting the received microblog topics. The method further includes, displaying one or more first microblog topics of the sorted microblog topics on a center area of an interface of the mobile terminal, and displaying the rest of the sorted microblog topics around the center area toward one or more sides of the interface.

According to another embodiment, a mobile terminal includes a transmission module, a receiving module, a sorting module, and a displaying module. The transmission module is configured to send a post that includes at least a first geographic location of the mobile terminal to a server so that the server can search for microblog topics associated with the first geographic location of the mobile terminal based on at least information associated with the post. The receiving module is configured to receive the microblog topics sent by the server. The sorting module is configured to sort the received microblog topics. The displaying module is configured to display one or more first microblog topics of the sorted microblog topics on a center area of an interface of the mobile terminal and display the rest of the sorted microblog topics around the center area toward one or more sides of the interface.

In one embodiment, a method for displaying microblog topics includes, sending by a mobile terminal a post that includes at least a first geographic location of the mobile terminal to a server so that the server can search for microblog topics associated with the first geographic location of the mobile terminal based on at least information associated with the post, receiving the microblog topics sent by the server, and sorting the received microblog topics. The method further includes, displaying one or more first microblog topics of the sorted microblog topics on a center area of an interface of the mobile terminal, displaying the rest of the sorted microblog topics around the center area toward one or more sides of the interface, and displaying, by the mobile terminal, the sorted microblog topics in fonts which become smaller from the center area toward the one or more sides of the interface, the fonts being larger than or equal to a predetermined limit. The sorting the received microblog topics includes, sorting, by the mobile terminal, the received microblog topics in a descending order according to a quantity of microblogs associated with each of the received microblog topics. The sorting the received microblog topics further includes, sorting, by the mobile terminal, the received microblog topics in an ascending order according to distances between the first geographic location of the mobile terminal and second geographic locations of the received microblog topics, the second geographic locations of the received microblog topics including a third geographic location of a user when the user posts one of the received microblog topics, and in response to two or more of the received microblog topics corresponding to a same second geographic location, sorting, by the mobile terminal, the received microblog topics in a descending order according to a quantity of microblogs associated with each of the received microblog topics.

In another embodiment, a mobile terminal includes, a transmission module, a receiving module, a sorting module, and a displaying module. The transmission module is configured to send a post that includes at least a first geographic location of the mobile terminal to a server so that the server can search for microblog topics associated with the first geographic location of the mobile terminal based on at least information associated with the post. The receiving module is configured to receive the microblog topics sent by the server. The sorting module is configured to sort the received microblog topics. The displaying module is configured to display one or more first microblog topics of the sorted microblog topics on a center area of an interface of the mobile terminal and display the rest of the sorted microblog topics around the center area toward one or more sides of the interface. The displaying module is further configured to display the sorted microblog topics in fonts which become smaller from the center area toward the one or more sides of the interface, the fonts being larger than or equal to a predetermined limit. The sorting module includes, a first sorting unit configured to sort the received microblog topics in a descending order according to a quantity of microblogs associated with each of the received microblog topics, a second sorting unit configured to sort the received microblog topics in an ascending order according to distances between the first geographic location of the mobile terminal and second geographic locations of the received microblog topics, the second geographic locations of the received microblog topics including a third geographic location of a user when the user posts one of the received microblog topics, and a third sorting unit configured to, in response to two or more of the received microblog topics corresponding to a same second geographic location, sort the received microblog topics in a descending order according to a quantity of microblogs associated with each of the received microblog topics.

Depending upon embodiment, one or more benefits may be achieved. These benefits and various additional objects, features and advantages of the present invention can be fully appreciated with reference to the detailed description and accompanying drawings that follow.

For example, methods and mobile terminals described herein can sort received microblog topics, display one or more first microblog topics of the sorted microblog topics on a center area of an interface of a mobile terminal and display the rest of the sorted microblog topics around the center area toward one or more sides of the interface, so as to highlight the relevancy of the microblog topics according to their respective display positions and reduce the difficulty in obtaining relevant information. Moreover, methods and mobile terminals described herein can display the microblog topics in fonts which become smaller from the center area toward the one or more sides of the interface, the fonts being smaller than or equal to a predetermined limit, so as to highlight the relevancy of microblog topics according to the font size of the microblog topics and further reduce the difficulty in obtaining relevant information.

### 4. BRIEF DESCRIPTION OF THE DRAWINGS

FIG. 1 is a simplified diagram showing a method for displaying microblog topics according to one embodiment of the present invention;

FIG. 2 is a simplified diagram showing a method for displaying microblog topics according to another embodiment of the present invention;

FIG. 3 is a simplified diagram showing an interface of a mobile terminal for displaying microblog topics according to one embodiment of the present invention;

FIG. 4 is a simplified diagram showing an interface of a mobile terminal for displaying microblog topics according to another embodiment of the present invention;

FIG. 5 is a simplified diagram showing a method for displaying microblog topics according to yet another embodiment of the present invention;

FIG. 6 is a simplified diagram showing certain components of a mobile terminal according to one embodiment of the present invention;

FIG. 7 is a simplified diagram showing certain components of the sorting module as part of the mobile terminal as shown in FIG. 6 according to one embodiment of the present invention.

### 5. DETAILED DESCRIPTION OF THE INVENTION

The present invention is directed to communication technology. More particularly, the invention provides systems and methods for displaying information. Merely by way of example, the invention has been applied to microblogs. But it would be recognized that the invention has a much broader range of applicability.

As discussed above, in the conventional technology, a mobile terminal displays multiple microblog topics in a same list format or a same tag format. But a user may not easily determine the relevancy of the microblog topics displayed in a list format or in a tag format on the mobile terminal, and thus it is often inconvenient for the user to obtain relevant information.

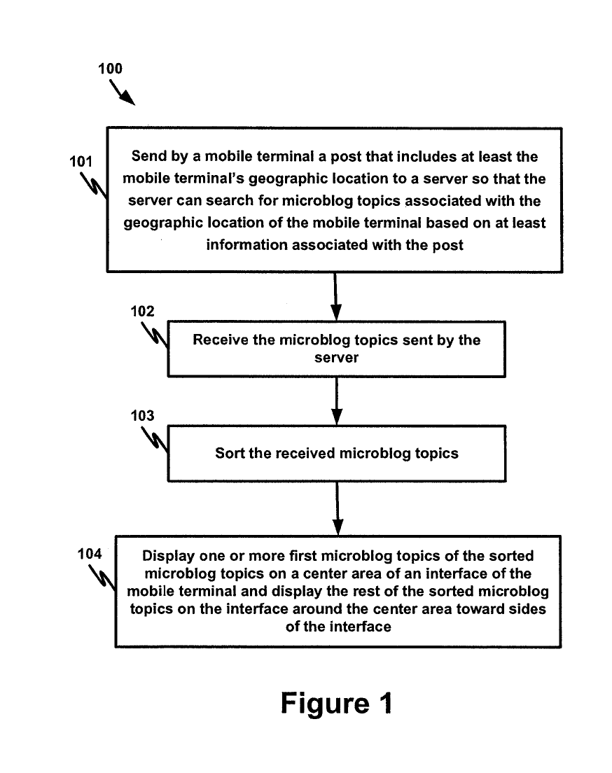

FIG. 1 is a simplified diagram showing a method for displaying microblog topics according to one embodiment of the present invention. This diagram is merely an example, which should not unduly limit the scope of the claims. One of ordinary skill in the art would recognize many variations, alternatives, and modifications. The method 100 for displaying microblog topics includes at least a process 101 for sending, by a mobile terminal, a post to a server so that the server can search for relevant microblog topics, a process 102 for receiving the microblog topics sent by the server, a process 103 for sorting the received microblog topics, and a process 104 for displaying the sorted microblog topics.

As shown in FIG. 1, at the process 101, the mobile terminal (e.g., a cell phone, a tablet computer, a laptop, etc.) sends to the server a post that includes at least a geographic location of the mobile terminal, so that the server can search for the microblog topics associated with the geographic location of the mobile terminal based on at least information associated with the post, according to certain embodiments. For example, the mobile terminal receives the microblog topics sent by the server, at the process 102. In another example, the mobile terminal sorts the received microblog topics, at the process 103. The mobile terminal displays one or more first microblog topics of the sorted microblog topics on a center area of an interface (e.g., a screen, a graphic user interface, a display, etc.) of the mobile terminal, and displays the rest of the sorted microblog topics around the center area toward one or more sides of the mobile terminal, at the process 104, according to some embodiments.

Specifically, after the mobile terminal displays the one or more first microblog topics of the sorted microblog topics on the center area of the interface of the mobile terminal and the rest of the sorted microblog topics around the center area, the mobile terminal displays the sorted microblog topics in fonts which become smaller from the center area toward one or more sides of the interface, and the fonts are kept larger than or equal to a predetermined limit, according to one embodiment.

In another embodiment, at the process 103, the mobile terminal sorts the microblog topics received from the server in a descending order according to a quantity of microblogs associated with each of the received microblog topics. As an example, the process 103 includes, sorting, by the mobile terminal, the received microblog topics in an ascending order according to distances between the geographic location of the mobile terminal and geographic locations of the received microblog topics. In one example, a geographic location of one of the received microblog topics corresponds to a geographic location of a user when the user posts the microblog topic.

In yet another embodiment, after the mobile terminal sorts the microblog topics received from the server according to the distances between the geographic location of the mobile terminal and the geographic locations of the received microblog topics, if multiple microblog topics correspond to a same geographic location, the mobile terminal sorts the microblog topics in a descending order according to the quantity of microblogs associated with each of the microblog topics.

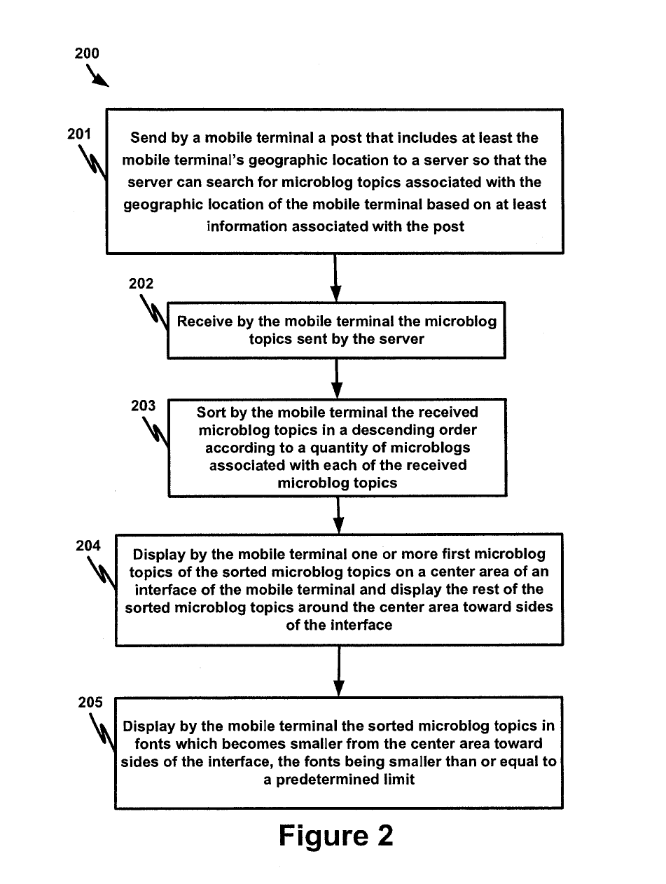

FIG. 2 is a simplified diagram showing a method for displaying microblog topics according to another embodiment of the present invention. This diagram is merely an example, which should not unduly limit the scope of the claims. One of ordinary skill in the art would recognize many variations, alternatives, and modifications. The method 200 for displaying microblog topics includes at least a process 201 for sending, by a mobile terminal, a post to a server so that the server can search for relevant microblog topics, a process 202 for receiving, at the mobile terminal, the microblog topics sent by the server, a process 203 for sorting the received microblog topics according to a quantity of microblogs associated with each of the received microblog topics, a process 204 for displaying one or more first microblog topics of the sorted microblog topics on a center area of an interface of the mobile terminal and displaying the rest of the sorted microblog topics around the center area toward sides of the interface, and a process 205 for displaying the sorted microblog topics in fonts which becomes smaller from the center area toward sides of the interface.

As shown in FIG. 2, at the process 201, the mobile terminal sends a post that includes at least the mobile terminal's geographic location to the server so that the server can search for microblog topics associated with the geographic location of the mobile terminal based on at least information associated with the post, according to some embodiments. For example, a post refers to a message that is sent to the server when a user posts a microblog topic or posts a microblog associated with a particular microblog topic. In another example, the user can determine whether to disclose the user's current geographic location before the post is sent to the server. If the user, as an example, chooses to disclose his/her geographic location, the mobile terminal obtains its geographic location and adds such information to the post that is sent to the server. The server may display the geographic location of the mobile terminal on a microblog interface. On the other hand, if the user chooses not to disclose his/her geographic location, the mobile terminal does not need to obtain its own geographic location. In one embodiment, the post contains information related to the current geographic location of the mobile terminal.

Specifically, there are many ways for the mobile terminal to acquire its geographic location, in some embodiments. For example, the mobile terminal can determine its geographic location using GPS (Global Positioning System), a base station of the mobile network, WiFi (Wireless Fidelity) hotspots, or other possible means.

According to one embodiment, the server obtains the geographic location of the mobile terminal in the post and searches for microblog topics associated with the geographic location within a microblog-topic library (e.g., a list of micro-blog topics). A microblog topic posted by a user at a particular time may be determined to be associated with the geographic location of the mobile terminal if the distance between the geographic location of the user at that particular time and the geographic location of the mobile terminal satisfies one or more predetermined conditions, in some embodiments. For example, if the one or more predetermined conditions include that the distance is equal to zero, the server searches for microblog topics having a same geographic location as the mobile terminal. In another example, if the one or more predetermined conditions includes that the distance is equal to or smaller than a predetermined threshold (e.g., 1 km), the server searches for microblog topics with a geographical location within a distance of 1 km from the geographic location of the mobile terminal.

According to another embodiment, if the one or more predetermined conditions includes that the distance is equal to or smaller than a predetermined threshold, an intermediate distance is selected from the range of [0, the predetermined threshold] to limit the search scope. For example, the intermediate distance may be increased gradually to increase the search scope, until it reaches the predetermined threshold. As an example, microblog topics close to a geographic location of a user may be preferentially searched so as to increase the relevancy of the microblog topics to the user. For example, if the predetermined threshold is equal to 2 km, two intermediate distances, 0.5 km and 1 km, may be chosen. The server may first search, in the microblog-topic library, for microblog topics having a distance smaller than or equal to 0.5 km from the geographic location of the mobile terminal. Then, the server may search for microblog topics having a distance larger than 0.5 km and smaller than or equal to 1 km from the geographic location of the mobile terminal. Thereafter, the server may search for microblog topics having a distance larger than 1 km and smaller than or equal to 2 km from the geographic location of the mobile terminal, until the end of the search process. As an example, if the geographic location of the mobile terminal changes, the server searches for relevant microblog topics according to a new geographic location of the mobile terminal and send the microblog topics associated with the new geographic location to the mobile terminal for display.

As shown in FIG. 2, at the process 202, the mobile terminal receives the relevant microblog topics sent by the server, according to one embodiment. For example, the mobile terminal sorts the received microblog topics in a descending order according to a quantity of microblogs associated with each of the received microblog topics, at the process 203. Specifically, after a microblog topic is posted, as an example, a user can comment on such topic by posting a microblog. For example, the quantity of microblogs associated with the microblog topic indicates the popularity of the topic. In one embodiment, the mobile terminal sorts the microblog topics received according to the quantity of microblogs associated with the microblog topics and displays popular microblog topics to the user to highlight the relevancy of the microblog topics.

According to some embodiments, at the process 204, the mobile terminal displays the one or more first microblog topics of the sorted microblog topics on the center area of the interface of the mobile terminal, and displays the rest of the sorted microblog topics around the center area toward one or more sides of the interface. In one embodiment, the mobile terminal divides the sorted microblog topics into different levels before displaying the microblog topics. For example, a first level includes the one or more first microblog topics, and other levels each include at least one microblog topic. As an example, microblog topics of a same level are displayed on the interface with same visual effects. In another example, if the mobile terminal contains a plurality of levels, the microblog topics at the first level are displayed on the center area of the interface; the microblog topic(s) at the second level are displayed around the microblog topics of the first level (e.g., in a radiated manner); the microblog topic(s) of the third level are displayed around the microblog topic(s) of the second level (e.g., in a radiated manner) until the microblog topics of all levels are displayed.

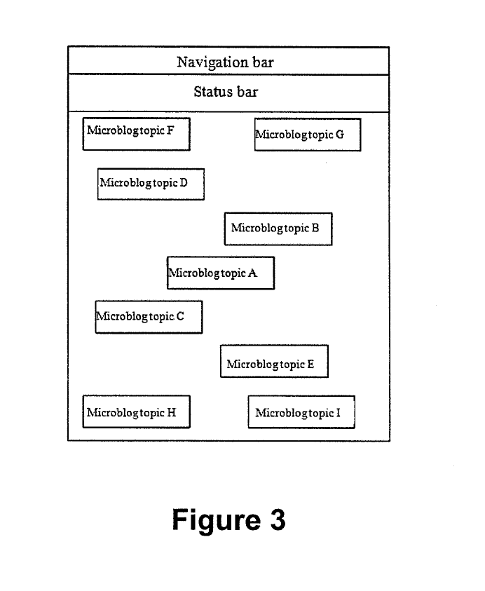

For instance, the sorted microblog topics include A, B, C, D, E, F, G, H and I which are displayed on the interface as follows: A is assigned to a first level; B and C to a second level; D and E to the third level; and F, G, H and I to the fourth level. A is displayed on the center area of the interface; B and C around A (e.g., in a radiated manner); D and E around B and C (e.g., in a radiated manner); and F, G, H and I around D and E (e.g., in a radiated manner), as shown in FIG. 3.

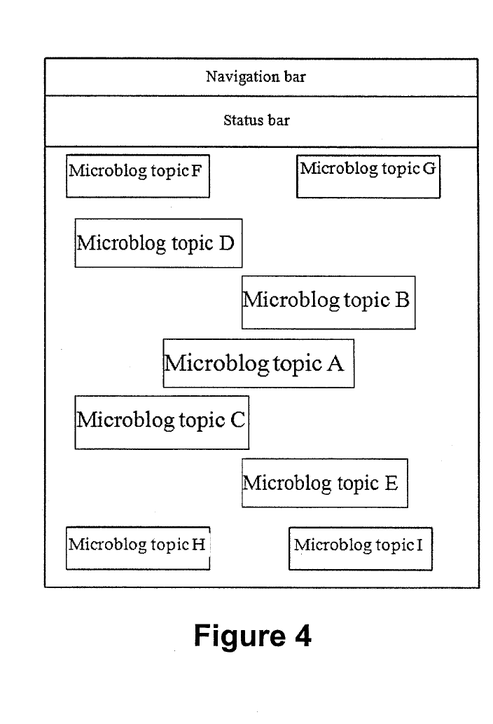

Referring back to FIG. 2, the process 205 includes displaying, by the mobile terminal, the sorted microblog topics in fonts which becomes smaller from the center area toward sides of the interface, the fonts being smaller than or equal to a predetermined limit, according to some embodiments. In one embodiment, the mobile terminal displays the microblog topics in fonts which become smaller from the center area outwardly toward the sides of the interface in order to enhance the visual effects. For instance, the font size of microblog topics can be set according to different levels. As an example, the microblog topic(s) at the first level is set to have a font size of No. 3, and the microblog topic(s) at the second level is set to have a font size of No. 4, as shown in FIG. 4.

If there are too many microblog topics of a particular geographic location, the microblog topics at lower levels may have such small fonts that the topics cannot be clearly displayed, in some embodiments. For example, the mobile terminal may set a minimum font size. When a particular microblog topic is displayed with the minimum font size, all microblog topics at lower levels are displayed with the minimum font size, according to one embodiment. The mobile terminal can enhance visual effects of microblog topics by using bold fonts, setting font colors and/or background colors, etc., to further distinguish different microblog topics, according to certain embodiments.

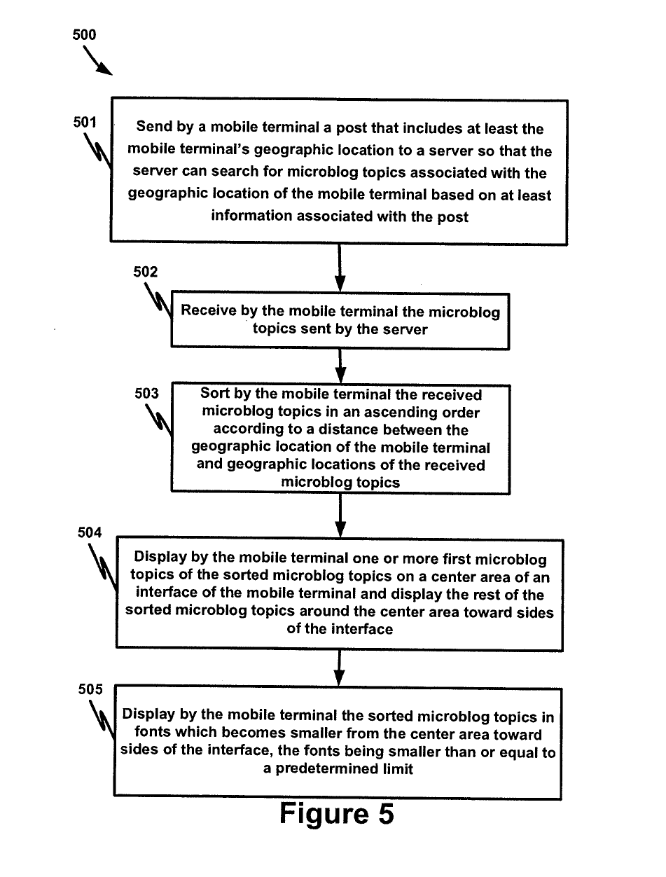

FIG. 5 is a simplified diagram showing a method for displaying microblog topics according to yet another embodiment of the present invention. This diagram is merely an example, which should not unduly limit the scope of the claims. One of ordinary skill in the art would recognize many variations, alternatives, and modifications. The method 500 for displaying microblog topics includes at least a process 501 for sending, by a mobile terminal, a post to a server so that the server can search for relevant microblog topics, a process 502 for receiving the microblog topics sent by the server, a process 503 for sorting the received microblog topics according to a distance between the geographic location of the mobile terminal and geographic locations of the received microblog topics, a process 504 for displaying one or more first microblog topics of the sorted microblog topics on a center area of an interface of the mobile terminal and display the rest of the sorted microblog topics around the center area toward sides of the interface, and a process of 505 for displaying the sorted microblog topics in fonts which becomes smaller from the center area toward sides of the interfaces.

As shown in FIG. 5, the process 501 includes sending by the mobile terminal the post that includes at least the mobile terminal's geographic location to the server so that the server can search for microblog topics associated with the geographic location of the mobile terminal based on at least information associated with the post, according to certain embodiments. For example, a post refers to a message that is sent to the server when a user posts a microblog topic or posts a microblog associated with a particular microblog topic. In one embodiment, the post contains information related to the current geographic location of the mobile terminal. The server searches for the microblog topics associated with the geographic location of the mobile terminal, similar to what is described in the process 201. For example, if the geographic location of the mobile terminal changes, the server searches for the microblog topics according to the new geographic location and send the microblog topics associated with the new geographic location to the mobile terminal for display.

According to one embodiment, at the process 502, the mobile terminal receives the microblog topics sent by the server, and at the process 503, the mobile terminal sorts the received microblog topics in an ascending order according to a distance between the geographic location of the mobile terminal and geographic locations of the received microblog topics. For example, a geographic location of one of the received microblog topics corresponds to a geographic location of a user when the user posts the microblog topic.

In one embodiment, the mobile terminal sorts the received microblog topics in an ascending order according to distances between the geographic locations of the received microblog topics and the geographic location of the mobile terminal, so that microblog topics close to a geographic location of a user may be preferentially searched for to increase the relevancy of the microblog topics to the user.

According to some embodiments, the process 504 includes displaying by the mobile terminal one or more first microblog topics of the sorted microblog topics on a center area of an interface of the mobile terminal and display the rest of the sorted microblog topics around the center area toward sides of the interface. In one embodiment, the mobile terminal divides the sorted microblog topics into different levels before displaying the microblog topics. For example, a first level includes the one or more first microblog topics, and other levels each include at least one microblog topic. As an example, microblog topics of a same level are displayed on the interface with same visual effects. In another example, if the mobile terminal contains a plurality of levels, the microblog topics at the first level are displayed on the center area of the interface; the microblog topic(s) at the second level are displayed around the microblog topics of the first level (e.g., in a radiated manner); the microblog topic(s) of the third level are displayed around the microblog topic(s) of the second level (e.g., in a radiated manner) until the microblog topics of all levels are displayed.

According to certain embodiments, at the process 505, the mobile terminal displays the sorted microblog topics in fonts which becomes smaller from the center area toward sides of the interface, the fonts being smaller than or equal to a predetermined limit. In one embodiment, the mobile terminal displays the microblog topics in fonts which become smaller from the center area outwardly toward the sides of the interface in order to enhance the visual effects. For instance, the font size of microblog topics can be set according to different levels. As an example, the microblog topic(s) at the first level is set to have a font size of No. 3, and the microblog topic(s) at the second level is set to have a font size of No. 4.

If there are too many microblog topics of a particular geographic location, the microblog topics at lower levels may have such small fonts that the topics cannot be clearly displayed, in some embodiments. For example, the mobile terminal may set a minimum font size. When a particular microblog topic is displayed with the minimum font size, all microblog topics at lower levels are displayed with the minimum font size, according one embodiment. The mobile terminal can enhance visual effects of microblog topics by using bold fonts, setting font colors and/or background colors, etc., to further distinguish different microblog topics, according to certain embodiments.

As described above and further emphasized here, FIGS. 2 and 5 are merely examples, which should not unduly limit the scope of the claims. One of ordinary skill in the art would recognize many variations, alternatives, and modifications. For example, the process 503 may be combined with the process 203 so as to implement a different sorting process which includes, sorting, by the mobile terminal, the received microblog topics in an ascending order according to distances between the geographic location of the mobile terminal and geographic locations of the received microblog topics, and if two or more of the received microblog topics corresponds to a same geographic location, sorting, by the mobile terminal, the received microblog topics in a descending order according to a quantity of microblogs associated with each of the received microblog topics.

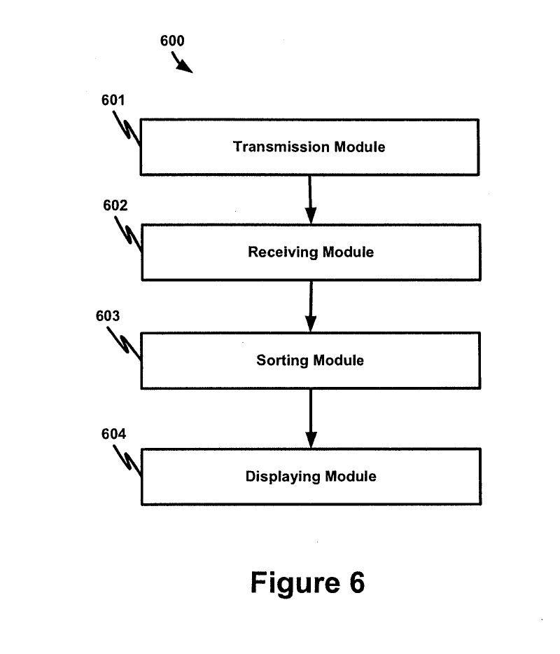

FIG. 6 is a simplified diagram showing certain components of a mobile terminal according to one embodiment of the present invention. This diagram is merely an example, which should not unduly limit the scope of the claims. One of ordinary skill in the art would recognize many variations, alternatives, and modifications. As shown in FIG. 6, a mobile terminal 600 includes a transmission module 601, a receiving module 602, a sorting module 603, and a displaying module 604.

According to one embodiment, the transmission module 601 is configured to send a post that includes at least a geographic location of the mobile terminal 600 to a server so that the server can search for microblog topics associated with the geographic location of the mobile terminal 600 based on at least information associated with the post. For example, the receiving module 602 is configured to receive the microblog topics sent by the server. In another example, the sorting module 603 is configured to sort the received microblog topics. In yet another example, the displaying module 604 is configured to display one or more first microblog topics of the sorted microblog topics on a center area of an interface of the mobile terminal and display the rest of the sorted microblog topics around the center area toward one or more sides of the interface (e.g., in a radiated manner). In yet another example, the displaying module 604 is further configured to display the sorted microblog topics in fonts which become smaller from the center area toward the one or more sides of the interface, the fonts being larger than or equal to a predetermined limit.

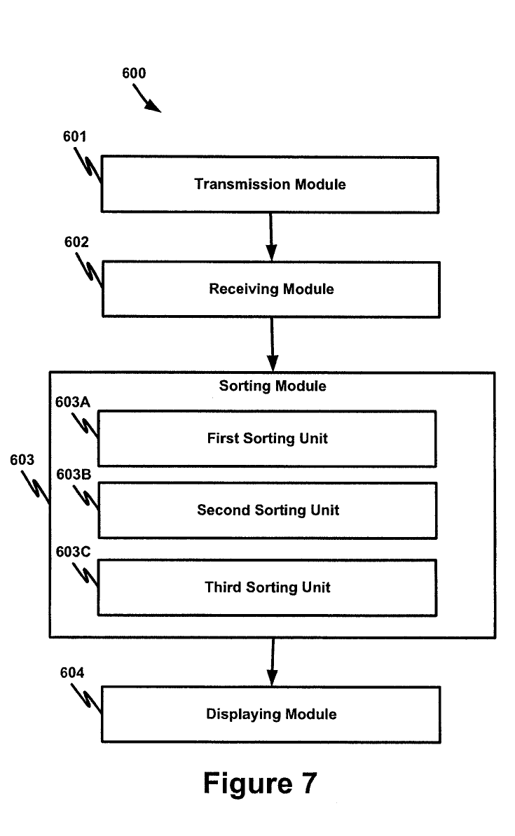

FIG. 7 is a simplified diagram showing certain components of the sorting module 603 as part of the mobile terminal 600 according to one embodiment of the present invention. This diagram is merely an example, which should not unduly limit the scope of the claims. One of ordinary skill in the art would recognize many variations, alternatives, and modifications. As shown in FIG. 7, the sorting module 603 includes a first sorting unit 603A, a second sorting unit 603B, and a third sorting unit 603C.

100481 According to one embodiment, the first sorting unit 603A is configured to sort the received microblog topics in a descending order according to a quantity of microblogs associated with each of the received microblog topics. For example, the second sorting unit 603B is configured to sort the received microblog topics in an ascending order according to distances between the geographic location of the mobile terminal and the geographic locations of the received microblog topics. In another example, a geographic location of one of the received microblog topics corresponds to a geographic location of a user when the user posts the microblog topic. In yet another example, a third sorting unit 603C is configured to, in response to two or more of the received microblog topics corresponding to a same geographic location, sort the received microblog topics in a descending order according to a quantity of microblogs associated with each of the received microblog topics.

As described above and further emphasized here, FIGS. 6 and 7 are merely examples, which should not unduly limit the scope of the claims. One of ordinary skill in the art would recognize many variations, alternatives, and modifications. For example, the mobile terminal 600 can execute the methods for displaying microblog topics as shown in FIG. 1, FIG. 2, and/or FIG. 5. As an example, the mobile terminal 600 may include different modules from those shown in FIG. 6 and/or FIG. 7, or any module shown in FIG. 6 and/or FIG. 7 may be divided into different functional modules to complete all or part of the above-noted functions.

According to one embodiment, a method for displaying microblog topics includes: sending by a mobile terminal a post that includes at least a first geographic location of the mobile terminal to a server so that the server can search for microblog topics associated with the first geographic location of the mobile terminal based on at least information associated with the post, receiving the microblog topics sent by the server, and sorting the received microblog topics. The method further includes, displaying one or more first microblog topics of the sorted microblog topics on a center area of an interface of the mobile terminal, and displaying the rest of the sorted microblog topics around the center area toward one or more sides of the interface. For example, the method is implemented according to FIG. 1, FIG. 2, FIG. 5, FIG. 6, and/or FIG. 7.

According to another embodiment, a mobile terminal includes a transmission module, a receiving module, a sorting module, and a displaying module. The transmission module is configured to send a post that includes at least a first geographic location of the mobile terminal to a server so that the server can search for microblog topics associated with the first geographic location of the mobile terminal based on at least information associated with the post. The receiving module is configured to receive the microblog topics sent by the server. The sorting module is configured to sort the received microblog topics. The displaying module is configured to display one or more first microblog topics of the sorted microblog topics on a center area of an interface of the mobile terminal and display the rest of the sorted microblog topics around the center area toward one or more sides of the interface. For example, the mobile terminal is implemented according to FIG. 1, FIG. 2, FIG. 5, FIG. 6, and/or FIG. 7.

In one embodiment, a method for displaying microblog topics includes, sending by a mobile terminal a post that includes at least a first geographic location of the mobile terminal to a server so that the server can search for microblog topics associated with the first geographic location of the mobile terminal based on at least information associated with the post, receiving the microblog topics sent by the server, and sorting the received microblog topics. The method further includes, displaying one or more first microblog topics of the sorted microblog topics on a center area of an interface of the mobile terminal, displaying the rest of the sorted microblog topics around the center area toward one or more sides of the interface, and displaying, by the mobile terminal, the sorted microblog topics in fonts which become smaller from the center area toward the one or more sides of the interface, the fonts being larger than or equal to a predetermined limit. The sorting the received microblog topics includes, sorting, by the mobile terminal, the received microblog topics in a descending order according to a quantity of microblogs associated with each of the received microblog topics. The sorting the received microblog topics further includes, sorting, by the mobile terminal, the received microblog topics in an ascending order according to distances between the first geographic location of the mobile terminal and second geographic locations of the received microblog topics, the second geographic locations of the received microblog topics including a third geographic location of a user when the user posts one of the received microblog topics, and in response to two or more of the received microblog topics corresponding to a same second geographic location, sorting, by the mobile terminal, the received microblog topics in a descending order according to a quantity of microblogs associated with each of the received microblog topics. For example, the method is implemented according to FIG. 1, FIG. 2, FIG. 5, FIG. 6, and/or FIG. 7.

In another embodiment, a mobile terminal includes, a transmission module, a receiving module, a sorting module, and a displaying module. The transmission module is configured to send a post that includes at least a first geographic location of the mobile terminal to a server so that the server can search for microblog topics associated with the first geographic location of the mobile terminal based on at least information associated with the post. The receiving module is configured to receive the microblog topics sent by the server. The sorting module is configured to sort the received microblog topics. The displaying module is configured to display one or more first microblog topics of the sorted microblog topics on a center area of an interface of the mobile terminal and display the rest of the sorted microblog topics around the center area toward one or more sides of the interface. The displaying module is further configured to display the sorted microblog topics in fonts which become smaller from the center area toward the one or more sides of the interface, the fonts being larger than or equal to a predetermined limit. The sorting module includes, a first sorting unit configured to sort the received microblog topics in a descending order according to a quantity of microblogs associated with each of the received microblog topics, a second sorting unit configured to sort the received microblog topics in an ascending order according to distances between the first geographic location of the mobile terminal and second geographic locations of the received microblog topics, the second geographic locations of the received microblog topics including a third geographic location of a user when the user posts one of the received microblog topics, and a third sorting unit configured to, in response to two or more of the received microblog topics corresponding to a same second geographic location, sort the received microblog topics in a descending order according to a quantity of microblogs associated with each of the received microblog topics. For example, the mobile terminal is implemented according to FIG. 1, FIG. 2, FIG. 5, FIG. 6, and/or FIG. 7.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for displaying microblog topics, the method comprising:
sending by a mobile terminal a post that includes at least a first geographic location of the mobile terminal to a server so that the server can search for microblog topics associated with the first geographic location of the mobile terminal based on at least information associated with the post;
receiving the microblog topics sent by the server;
sorting the received microblog topics;
displaying one or more first microblog topics of the sorted microblog topics on a center area of an interface of the mobile terminal; and
displaying the rest of the sorted microblog topics around the center area toward one or more sides of the interface.

2. The method of claim 1, further comprising:
displaying, by the mobile terminal, the sorted microblog topics in fonts which become smaller from the center area toward the one or more sides of the interface, the fonts being larger than or equal to a predetermined limit.

3. The method of claim 1 wherein the sorting the received microblog topics includes:
sorting, by the mobile terminal, the received microblog topics in a descending order according to a quantity of microblogs associated with each of the received microblog topics.

4. The method of claim 1 wherein the sorting the received microblog topics includes:
sorting, by the mobile terminal, the received microblog topics in an ascending order according to distances between the first geographic location of the mobile terminal and second geographic locations of the received microblog topics;
wherein the second geographic locations of the received microblog topics include a third geographic location of a user when the user posts one of the received microblog topics.

5. The method of claim 4 where the sorting the received microblog topics further includes:
in response to two or more of the received microblog topics corresponding to a same second geographic location, sorting, by the mobile terminal, the received microblog topics in a descending order according to a quantity of microblogs associated with each of the received microblog topics.

6. A mobile terminal comprising:
a transmission module configured to send a post that includes at least a first geographic location of the mobile terminal to a server so that the server can search for microblog topics associated with the first geographic location of the mobile terminal based on at least information associated with the post;
a receiving module configured to receive the microblog topics sent by the server;
a sorting module configured to sort the received microblog topics; and
a displaying module configured to display one or more first microblog topics of the sorted microblog topics on a center area of an interface of the mobile terminal and display the rest of the sorted microblog topics around the center area toward one or more sides of the interface.

7. The mobile terminal of claim 6 wherein the displaying module is further configured to display the sorted microblog topics in fonts which become smaller from the center area toward the one or more sides of the interface, the fonts being larger than or equal to a predetermined limit.

8. The mobile terminal of claim 6 wherein the sorting module includes:
a first sorting unit configured to sort the received microblog topics in a descending order according to a quantity of microblogs associated with each of the received microblog topics.

9. The mobile terminal of claim 6 wherein:
the sorting module further includes a second sorting unit configured to sort the received microblog topics in an ascending order according to distances between the first geographic location of the mobile terminal and second geographic locations of the received microblog topics; and
the second geographic locations of the received microblog topics include a third geographic location of a user when the user posts one of the received microblog topics.

10. The mobile terminal of claim 9 wherein the sorting module further includes:
a third sorting unit configured to, in response to two or more of the received microblog topics corresponding to a same second geographic location, sort the received microblog topics in a descending order according to a quantity of microblogs associated with each of the received microblog topics.

11. A non-transitory computer readable medium comprising programming instructions for displaying microblog topics, the programming instructions configured to cause a processing system to execute operations comprising:
sending a post that includes at least a first geographic location of a mobile terminal to a server so that the server can search for microblog topics associated with the first geographic location of the mobile terminal based on at least information associated with the post;
receiving the microblog topics sent by the server;
sorting the received microblog topics;
displaying one or more first microblog topics of the sorted microblog topics on a center area of an interface of the mobile terminal; and
displaying the rest of the sorted microblog topics around the center area toward one or more sides of the interface.

12. A computer-implemented system for displaying microblog topics, said system comprising:
one or more data processors;
a computer-readable storage medium encoded with instructions for commanding the data processors to execute operations including:
sending a post that includes at least a first geographic location of a mobile terminal to a server so that the server can search for microblog topics associated with the first geographic location of the mobile terminal based on at least information associated with the post;
receiving the microblog topics sent by the server;
sorting the received microblog topics;
displaying one or more first microblog topics of the sorted microblog topics on a center area of an interface of the mobile terminal; and
displaying the rest of the sorted microblog topics around the center area toward one or more sides of the interface.

13. A method for displaying microblog topics, the method comprising:
sending by a mobile terminal a post that includes at least a first geographic location of the mobile terminal to a server so that the server can search for microblog topics associated with the first geographic location of the mobile terminal based on at least information associated with the post;
receiving the microblog topics sent by the server;
sorting the received microblog topics;
displaying one or more first microblog topics of the sorted microblog topics on a center area of an interface of the mobile terminal;
displaying the rest of the sorted microblog topics around the center area toward one or more sides of the interface; and
displaying, by the mobile terminal, the sorted microblog topics in fonts which become smaller from the center area toward the one or more sides of the interface, the fonts being larger than or equal to a predetermined limit;
wherein:
the sorting the received microblog topics includes, sorting, by the mobile terminal, the received microblog topics in a descending order according to a quantity of microblogs associated with each of the received microblog topics;
the sorting the received microblog topics further includes:
sorting, by the mobile terminal, the received microblog topics in an ascending order according to distances between the first geographic location of the mobile terminal and second geographic locations of the received microblog topics, the second geographic locations of the received microblog topics including a third geographic location of a user when the user posts one of the received microblog topics; and
in response to two or more of the received microblog topics corresponding to a same second geographic location, sorting, by the mobile terminal, the received microblog topics in a descending order according to a quantity of microblogs associated with each of the received microblog topics.

14. A mobile terminal comprising:
a transmission module configured to send a post that includes at least a first geographic location of the mobile terminal to a server so that the server can search for microblog topics associated with the first geographic location of the mobile terminal based on at least information associated with the post;
a receiving module configured to receive the microblog topics sent by the server;
a sorting module configured to sort the received microblog topics; and
a displaying module configured to display one or more first microblog topics of the sorted microblog topics on a center area of an interface of the mobile terminal and display the rest of the sorted microblog topics around the center area toward one or more sides of the interface;
wherein:
the displaying module is further configured to display the sorted microblog topics in fonts which become smaller from the center area toward the one or more sides of the interface, the fonts being larger than or equal to a predetermined limit;
the sorting module includes:
a first sorting unit configured to sort the received microblog topics in a descending order according to a quantity of microblogs associated with each of the received microblog topics;
a second sorting unit configured to sort the received microblog topics in an ascending order according to distances between the first geographic location of the mobile terminal and second geographic locations of the received microblog topics, the second geographic locations of the received microblog topics including a third geographic location of a user when the user posts one of the received microblog topics; and
a third sorting unit configured to, in response to two or more of the received microblog topics corresponding to a same second geographic location, sort the received microblog topics in a descending order according to a quantity of microblogs associated with each of the received microblog topics.
